(19) United States
(12) Patent Application Publication
(10) Pub. No.: US 2009/0238405 A1
(43) Pub. Date: Sep. 24, 2009

(54) METHOD AND SYSTEM FOR ENABLING A USER TO PLAY A LARGE SCREEN GAME BY MEANS OF A MOBILE DEVICE

(76) Inventor: Yaron Buznach, Lod (IL)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/096,140

(22) PCT Filed: Dec. 5, 2006
(86) PCT No.: PCT/IL06/01398

§ 371 Date: Oct. 24, 2008

Related U.S. Application Data
(60) Provisional application No. 60/741,895, filed on Dec. 5, 2005.

(51) Int. Cl. G06K 9/00; G06K 9/36

(52) U.S. Cl. 382/103; 382/232

(57) ABSTRACT

The present invention relates to a system and method for determining and tracking one or more objects, or one or more image sections within each image of a video stream to be displayed on user's mobile device, comprising: (a) one or more video streams to be run on a streaming server; (b) an image capture software component for capturing images of said one or more video streams, according to a first group of one or more sets of rules; (c) a receiver for receiving one or more commands generated by a user and transferring said commands to an extra-layer software component; (d) an extra-layer software component for: (d.1.) determining one or more objects or image sections within the captured images; (d.2.) tracking said objects or image sections within said captured images; and (d.3.) processing said captured images, to generate corresponding images to be displayed on a mobile device screen, according to a second group of one or more sets of rules and according to user's commands received by means of said receiver; (e) a compression software component for compressing the images, processed by means of said extra-layer software component, according to a third group of one or more sets of rules; (f) a data software component for providing groups of one or more sets of rules to said image capture software component, said extra-layer software component and said compression software component; and (g) a transmitter for transmitting the compressed images to a mobile device. The system and method further comprises a relayout software component for: (a) determining one or more objects or image sections within each image of the one or more video streams; (b) tracking said objects or image sections within said each image of said one or more video streams; and (c) processing said each image, to generate corresponding images to be displayed on a mobile device screen, according to a first group of one or more sets of rules and according to user's commands received by means of the receiver.

### FIELD OF THE INVENTION

The present invention relates to a method and system for playing games on mobile devices. More particularly, the invention relates to a method and system for enabling a user to play a game in real-time on a mobile device having a relatively small display, said game being originally designed to be played on a personal computer, PlayStation® or the like system, which uses a large screen.

### DEFINITIONS, ACRONYMS AND ABBREVIATIONS

Throughout this specification, the following definitions are employed:

DirectX: is a collection of APIs (Application Programming Interfaces) for handling tasks related to multimedia, especially game programming, on Microsoft® platforms. It is widely used in the development of computer games for the Microsoft Windows® Operating System.

Kernel: is the central component of most computer Operating Systems (OSs). Its responsibilities include managing system resources and communication between hardware and software components. As a basic component of an operating system, a kernel provides the lowest level of abstraction layer for the resources (especially memory, processors and Input/Output devices) that applications must control to perform their functions.

### BACKGROUND OF THE INVENTION

In the last decade, the worldwide use of mobile devices, such as cellular phones, PDAs (Personal Digital Assistants), etc. has increased dramatically. The modern mobile devices can capture and receive images of various sizes. In addition, they can capture and receive video films, video clips and display TV contents and it is required that the image or video data be able to be viewed on the display of said mobile devices. Also, paying games on mobile devices, such as cellular phones, is becoming very popular.

Usually, the physical dimensions of the mobile device display are small. In addition, the mobile device display contains a relatively small number of pixels. Therefore, the original image or video film is typically too large to be fully displayed on the small mobile device display. The image or video film size must therefore be reduced in order to fit into the display, which usually requires downscaling. Sometimes only part of the image contains interesting information, and therefore different levels of zooming/unzooming are required to show details of the area of interest. Zooming can be implemented, e.g., using upscaling or interpolation. The downscaling and upscaling should be of the same quality in order to prevent “noises” such as aliasing effects, etc. However, the prior art does not teach zooming and unzooming images of streaming video films or video games (that stream to users' mobile devices in real-time).

In addition, mobile platforms set limits on the amount of memory and computational resources allocated for image or video processing and enhancement. Large images or video films require a lot of memory and computational resources, which are directly related to the number of pixels in each image or video scene. According to the prior art, viewing large images of video films on a mobile device display is often an impossible task. The prior art solution for the problem of low memory or low computational resources is to limit the size of the image or video film to be displayed on the mobile device. However, in that case some images or video films cannot be displayed at all, in the case of insufficient memory or computational resources. In addition, when operating off-line, the image or video film can be downscaled during opening. Reducing the image or video film size during decoding allows larger images or video films to be displayed on the mobile device display. However, this solution is inappropriate for real-time applications, because it entails significant delays.

Due to the recent technological trends, mobile devices, such as cellular phones or PDAs often replace personal computers (PCs) for a variety of applications. Mobile devices are becoming more powerful and are able to handle complex tasks. In addition, more and more users play games on their mobile devices instead of their PCs or PlayStations®. However, due to the small dimensions of the mobile devices displays and to the problems discussed above, conventional games developed to be played on said mobile devices have poor image/video quality and are incomparable with the conventional PC or PlayStations® games. The prior art fails to provide means for overcoming these drawbacks and especially fails to enable a mobile device user to play modern games, such as 3D (3-dimensional) games, which are currently played on modern PCs and PlayStations®.

Several solutions have been proposed for displaying images or video data on mobile devices. For example, WO 2004/059979 discloses a file server communicating with a remote client (e.g. a mobile phone client), which receives images from a camera or a video store, as full frame images. A selection and compression program enables the transmission of bit streams defining a compressed image to be displayed on the comparatively small screen of the mobile client and permits virtual zoom and frame area selection to be viewed by the user. In another patent application US 2006/0007318, an image captured by a monitoring camera is stored in an image database in a monitoring system center apparatus, and is subsequently transmitted as an entire image to a cellular phone. When a user checks the image displayed on the cellular phone and determines that there is an object that the user desires to display in an enlarged form, the user accesses and instructs a WEB page provided by the center apparatus to display an enlarged display menu. US 2002/0092029 discloses a method of transmitting an image from a remote server to a portable device and dynamically viewing, by a human observer, the transmitted image on a display of the portable device. On a remote server, a master set of data representative of a graphic image is processed to form a first subset of data representative of a portion of the graphic image. The data is transmitted to the portable device and drawn on the display. The user selects a portion of the image to be further expanded and the master database is again processed to form a second subset of data representative of the selected portion of the image. The second subset of data is transmitted to the portable device and drawn on the display.

WO 2005/116922 relates to method and system for viewing and enhancing images on the display of a mobile device, which includes the display, memory and a processing means for bit images, and an input device for receiving bit images. A bit image is received and processed to a smaller scale in two stages, using pre-selected scaling algorithms. The bit image to be displayed is enhanced. Another patent application, WO 2005/075038, relates to a device with a user interface that depends on a game, for instance a mobile device such as a mobile phone with a user interface that is adapted to change in dependence of game events. The device is provided with a user interface, a control unit for controlling the operations of the device including changeable parameters of the user interface and further having a game platform for running a game. However, according to WO 2005/075038 the game is processed only on the device, which requires high processing resources and large memory means of said device; otherwise, the games having relatively high quality can not be played on said device.

The prior art has so far failed to provide a solution to the need to display high-quality video on small portable displays. Therefore, there is a continuous need to overcome the above prior art drawbacks.

It is an object of the present invention to provide a method and system to enable a user to play a high-quality video or game on a mobile device having a relatively small display. A high-quality video or game may originate from different sources and can be, for instance, a video stream originally designed to be played on a personal computer, PlayStation® or the like device, which employs a large screen.

It is another object of the present invention to provide a method and system for determining and tracking one or more objects and/or image sections within each image displayed on user's mobile device.

It is still another object of the present invention to provide a method and system for playing a game on a mobile device, which does not require high computational resources and large memory means in said mobile device.

It is still another object of the present invention to enable a user to play a game on a mobile device in real-time.

It is a further object of the present invention to enable a user playing a game on a mobile device to fully control said game by selecting an image section and objects to be displayed on the mobile device screen, zooming or unzooming the displayed image section and objects, moving them to any direction within said mobile device screen, and controlling applying various image processing filters on each game image, such as controlling the image brightness level, gamma level, contract level, frame rate, etc.

It is still a further object of the present invention to provide a method and system, which are user friendly.

It is still another object of the present invention to provide a method and system, which are relatively inexpensive to use.

Other objects and advantages of the invention will become apparent as the description proceeds.

### SUMMARY OF THE INVENTION

The present invention relates to a method and system for enabling a user to play a video or game in real-time on a mobile device having a relatively small display, said video or game being originally designed to be played on a personal computer, PlayStation® or the like by use of a large screen.

Although the following description will be provided with a particular reference to “games”, it will be appreciated by the skilled person that any type of video that can be, or is desired to be manipulated on a small screen such as that of a mobile device, will benefit from the present invention and is encompassed within it.

The system for determining and tracking one or more objects, or one or more image sections within each image of a video stream to be displayed on user's mobile device comprises: (a) one or more video streams to be run on a streaming server; (b) an image capture software component for capturing images of said one or more video streams, according to a first group of one or more sets of rules; (c) a receiver for receiving one or more commands generated by a user and transferring said commands to an extra-layer software component; (d) an extra-layer software component for: (d.1.) determining one or more objects or image sections within the captured images; (d.2.) tracking said objects or image sections within said captured images; and (d.3.) processing said captured images, to generate corresponding images to be displayed on a mobile device screen, according to a second group of one or more sets of rules and according to user's commands received by means of said receiver; (e) a compression software component for compressing the images, processed by means of said extra-layer software component, according to a third group of one or more sets of rules; (f) a data software component for providing groups of one or more sets of rules to said image capture software component, said extra-layer software component and said compression software component; and (g) a transmitter for transmitting the compressed images to a mobile device.

The system for determining and tracking one or more objects, or one or more image sections within each image of a video stream to be displayed on user's mobile device comprises: (a) one or more video streams to be run on a streaming server; (b) a receiver for receiving one or more commands generated by a user and transferring said commands to an extra-layer software component; (c) a relayout software component for: (c.1.) determining one or more objects or image sections within each image of said one or more video streams; (c.2.) tracking said objects or image sections within said each image of said one or more video streams; and (c.3.) processing said each image, to generate corresponding images to be displayed on a mobile device screen, according to a first group of one or more sets of rules and according to user's commands received by means of said receiver; (d) an image capture software component for capturing said corresponding images to be displayed on a mobile device screen, according to a second group of one or more sets of rules; (e) a compression software component for compressing said corresponding images to be displayed on a mobile device screen, according to a third group of one or more sets of rules; (f) a data software component for providing groups of one or more sets of rules to said relayout software component, said image capture software component and said compression software component; and (g) a transmitter for transmitting the compressed images to a mobile device.

Preferably, the images belong to a video game.

Preferably, the compressed images are decompressed in the mobile device and then displayed on the screen of said mobile device.

Preferably, tracking the one or more objects or the one or more image sections within each image is performed in real-time.

Preferably, the groups of sets of rules stored within the data software component, or the one or more commands generated by the user relate to one or more of the following: (a) selecting the object or image section within the one or more corresponding images displayed on the mobile device screen; (b) zooming or unzooming the object or image section within said one or more corresponding images; (c) moving the displayed image to any direction within said mobile device screen; (d) applying one or more image processing filters to said one or more corresponding images; and (e) determining one or more image compression parameters for compressing each corresponding image or for compressing a portion of said each corresponding image.

Preferably, the extra-layer software component further crops one or more images, according to the second group of sets of rules provided by the data software component, or according to the one or more commands generated by the user and received by means of the receiver.

Preferably, the relayout software component further crops one or more images, according to the first group of sets of rules provided by the data software component, or according to the one or more commands generated by the user and received by means of the receiver.

Preferably, the extra-layer software component modifies a layout of each captured image, generating corresponding images to be displayed on the mobile device screen, according to the second group of sets of rules provided by the data software component, or according to the one or more commands generated by the user and received by means of the receiver.

Preferably, the relayout software component modifies a layout of each image within the video stream, generating corresponding images to be displayed on the mobile device screen, according to the first group of sets of rules provided by the data software component, or according to the one or more commands generated by the user and received by means of the receiver.

The method for determining and tracking one or more objects, or one or more image sections within each image of a video stream to be displayed on user's mobile device comprises: (a) providing one or more video streams to be run on a streaming server; (b) providing an image capture software component for capturing images of said one or more video streams, according to a first group of one or more sets of rules; (c) providing a receiver for receiving one or more commands generated by a user and transferring said commands to an extra-layer software component; (d) providing an extra-layer software component for: (d.1.) determining one or more objects or image sections within the captured images; (d.2.) tracking said objects or image sections within said captured images; and (d.3.) processing said captured images, to generate corresponding images to be displayed on a mobile device screen, according to a second group of one or more sets of rules and according to user's commands received by means of said receiver; (e) providing a compression software component for compressing the images, processed by means of said extra-layer software component, according to a third group of one or more sets of rules; (f) providing a data software component for providing groups of one or more sets of rules to said image capture software component, said extra-layer software component and said compression software component; and (g) providing a transmitter for transmitting the compressed images to a mobile device.

The method for determining and tracking one or more objects, or one or more image sections within each image of a video stream to be displayed on user's mobile device comprises: (a) providing one or more video streams to be run on a streaming server; (b) providing a receiver for receiving one or more commands generated by a user and transferring said commands to an extra-layer software component; (c) providing a relayout software component for: (c.1.) determining one or more objects or image sections within each image of said one or more video streams; (c.2.) tracking said objects or image sections within said each image of said one or more video streams; and (c.3.) processing said each image, to generate corresponding images to be displayed on a mobile device screen, according to a first group of one or more sets of rules and according to user's commands received by means of said receiver; (d) providing an image capture software component for capturing said corresponding images to be displayed on a mobile device screen, according to a second group of one or more sets of rules; (e) providing a compression software component for compressing said corresponding images to be displayed on a mobile device screen, according to a third group of one or more sets of rules; (f) providing a data software component for providing groups of one or more sets of rules to said relayout software component, said image capture software component and said compression software component; and (g) providing a transmitter for transmitting the compressed images to a mobile device.

### BRIEF DESCRIPTION OF THE DRAWINGS

In the drawings:

FIG. 1A is a schematic illustration of a system for enabling users to play a video game in real-time on their mobile devices, according to a preferred embodiment of the present invention;

FIG. 1B is another schematic illustration of a system for enabling users to play a video game in real-time on their mobile devices, according to another preferred embodiment of the present invention;

FIG. 1C is a schematic flow chart of starting playing a game on a mobile device, according to a preferred embodiment of the present invention;

FIG. 2A is a schematic illustration of preparing one or more conventional PC/PlayStation® games for the play on each mobile device, according to a preferred embodiment of the present invention;

FIG. 2B is a schematic block diagram of Image/Object detection and tracking system located within the Games Server, according to a preferred embodiment of the present invention;

FIG. 2C is another schematic block diagram of Image/Object detection and tracking system located within the Games Server, according to another preferred embodiment of the present invention;

FIG. 2D is a schematic illustration of applying predefined rules to each mobile device, according to a preferred embodiment of the present invention;

FIG. 3A is a server side flow chart for enabling a user to play a game on his mobile device, according to a preferred embodiment of the present invention;

FIG. 3B is user's side flow chart for enabling a user to play a game on his mobile device, according to a preferred embodiment of the present invention;

FIG. 4 illustrates sample game images screenshots, according to a preferred embodiment of the present invention; and

FIG. 5 illustrates additional sample game images screenshots, according to another preferred embodiment of the present invention.

### DETAILED DESCRIPTION OF THE PREFERRED EMBODIMENTS

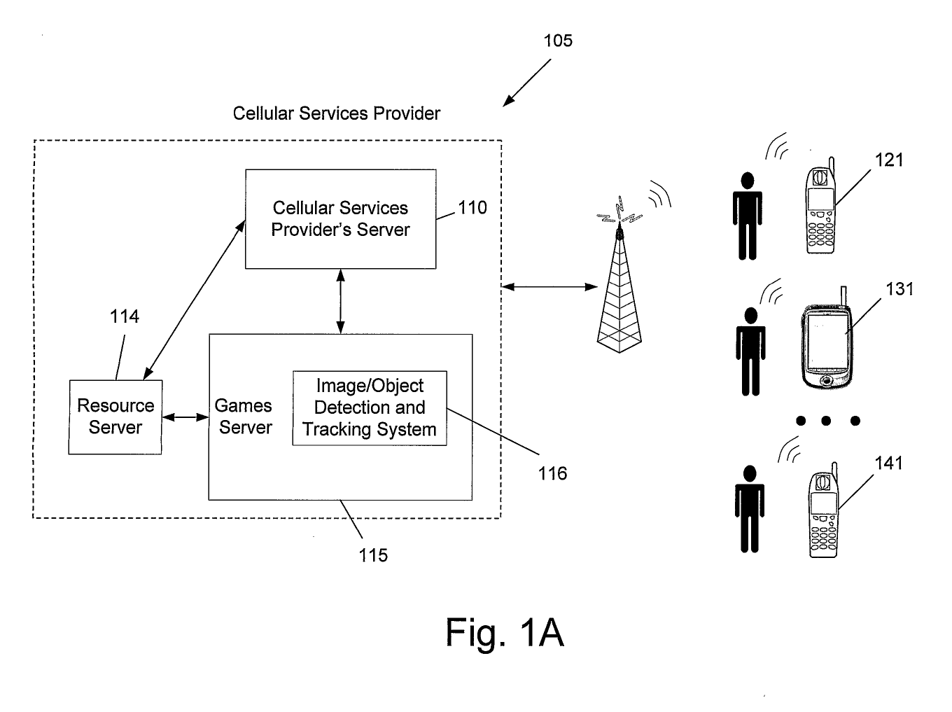

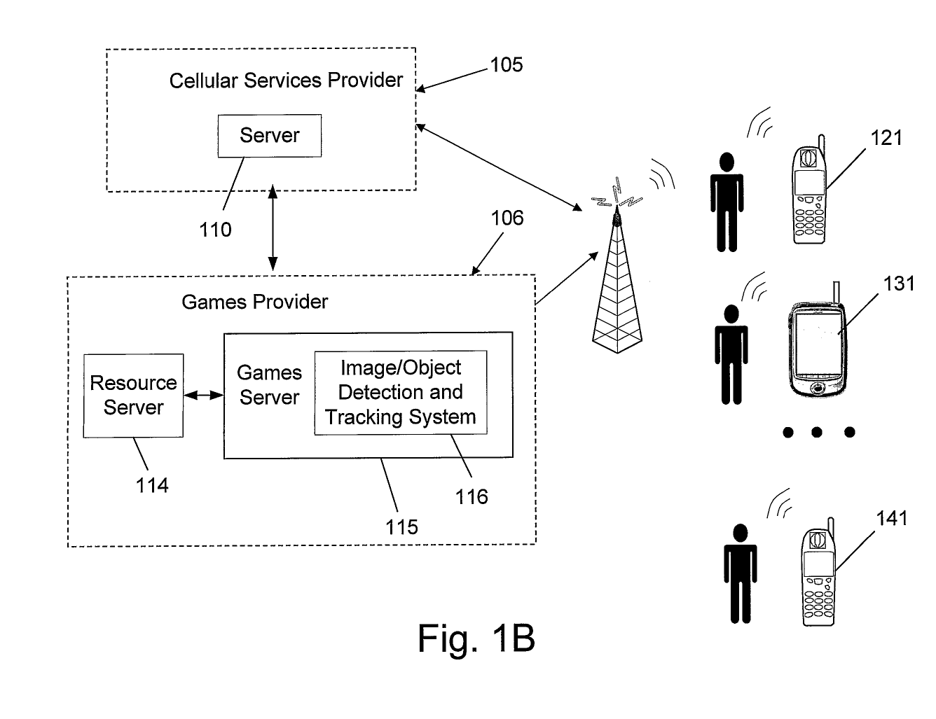

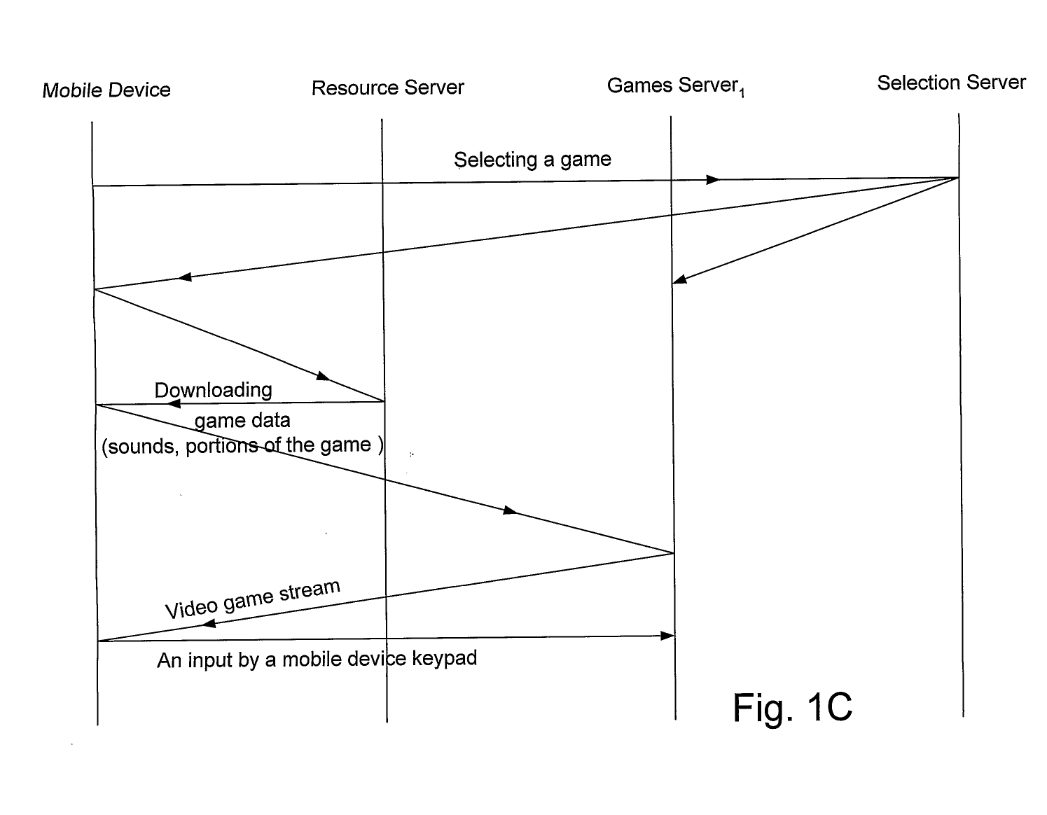

FIG. 1A is a schematic illustration of a system for enabling users to play a video game in real-time on their mobile devices, according to a preferred embodiment of the present invention. Cellular Services Provider 105 comprises Server 110 for providing conventional cellular services to mobile devices users (such as cellular phone calls, cellular Internet, SMS (Short Message Service), etc.); Games Server 115 for providing games to said users; and Resource Server 114 for uploading to a mobile device of each user sounds and/or portions of a corresponding game, selected by said each user to be played on his mobile device.

Games Server 115 comprises one or more games instances to be played on users' mobile devices, such as cellular phones 121 and 141, PDA (Personal Digital Assistant) 131, etc. The user wishing to play a game on his mobile device connects to Games Server 115 and selects a desirable game. Then, the user plays the selected game on his mobile device in real-time, while the instance of said game is physically running on said Games Server 115, which is a streaming server. Therefore, the mobile device of said user does not have to comprise high processing resources and large memory means.

For saving the transmission bandwidth during playing a game, according to a preferred embodiment of the present invention, the sounds and/or portions of said game are uploaded to each mobile device by means of Resource Server 114 prior to playing a game. When the user selects a desirable game to be played on his mobile device, Resource Server 114 starts uploading sounds and/or portions of said game to his mobile device. Thus, when playing a game, all available transmission bandwidth is allocated to the real-time video stream from Games Server 115 to the corresponding mobile device, that leads to providing a better video quality.

Games Server 115 comprises Image/Object detection and tracking system 116 for enabling the user to fully control the game process. The user playing the game by use of keypad 123 of his mobile device 121 can select a game object or game image section to be displayed on screen (display) 122 of said mobile device 121, to zoom/unzoom the selected object or image section, to move them to any direction within the mobile device screen, and to control applying various image processing filters on each game image, such as controlling the image brightness level, gamma level, contract level, frame rate, etc.

FIG. 1B is another schematic illustration of a system for enabling users to play a video game in real-time on their mobile devices, according to another preferred embodiment of the present invention. According to this preferred embodiment, Games Server 115 and/or Resource Server 114 are separated from Cellular Services Provider 105, and are located within Games Provider 106. Cellular Services Provider 105 uses services of Games Provider 106 for enabling its users to play games on their mobile devices. The user wishing to play a game on his mobile device connects to Games Server 115 and selects a desirable game. Then, the user plays the selected game on his mobile device in real-time, while the instance of said game is physically running on said Games Server 115. The sounds and/or portions of the selected game are uploaded to each mobile device by means of Resource Server 114 prior to playing a game.

FIG. 1C is a schematic flow chart of starting playing a game on a mobile device, according to a preferred embodiment of the present invention. The mobile device user selects a game to be played on his mobile device by means of his mobile device keypad. When selecting a game, the user is automatically connected to a Selection Server that selects a corresponding Games Server 115 (FIG. 1A), from which the video stream of the selected game will be further provided to user's mobile device. It is supposed, for example, that the Selection Server selects Games Server₁ for streaming the selected video game to user's mobile device. Then, the mobile device downloads sounds and/or portions of the selected game from Resource Server 114 (FIG. 1A) prior to starting playing the game. This can be done for saving the transmission bandwidth during playing a game. Thus, when playing a game, all available transmission bandwidth is allocated to the real-time video stream from Games Server 115 to the corresponding mobile device, that leads to providing a better video quality. When finishing downloading the sounds and/or portions of the selected game from said Resource Server, the mobile device instructs Games Server 115 to start providing the game video stream in real-time, and the user starts playing the game. During the game, the user inputs game commands (such as “turn left”, “jump”, “increase driving speed”, etc.) by pressing one or more buttons (keys) on his mobile device keypad. Then, Games Server 115 receives user's commands and processes them accordingly.

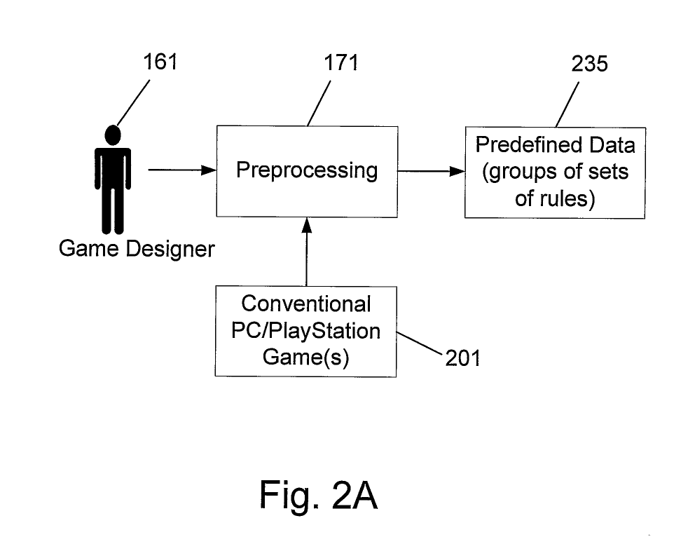

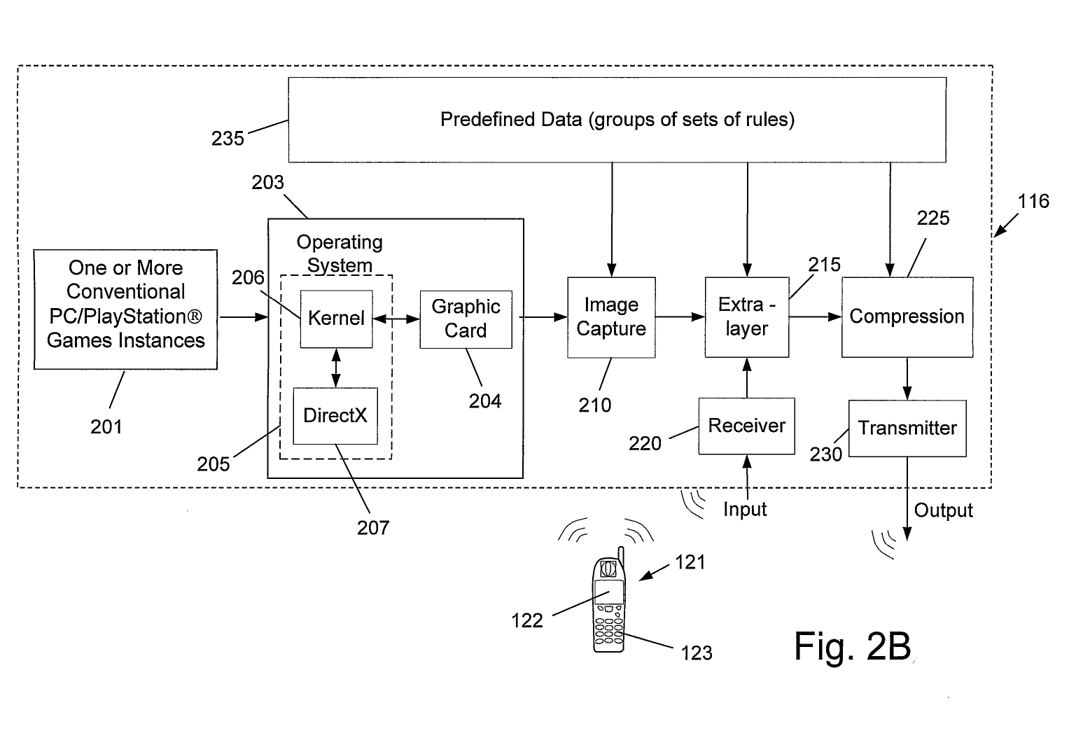

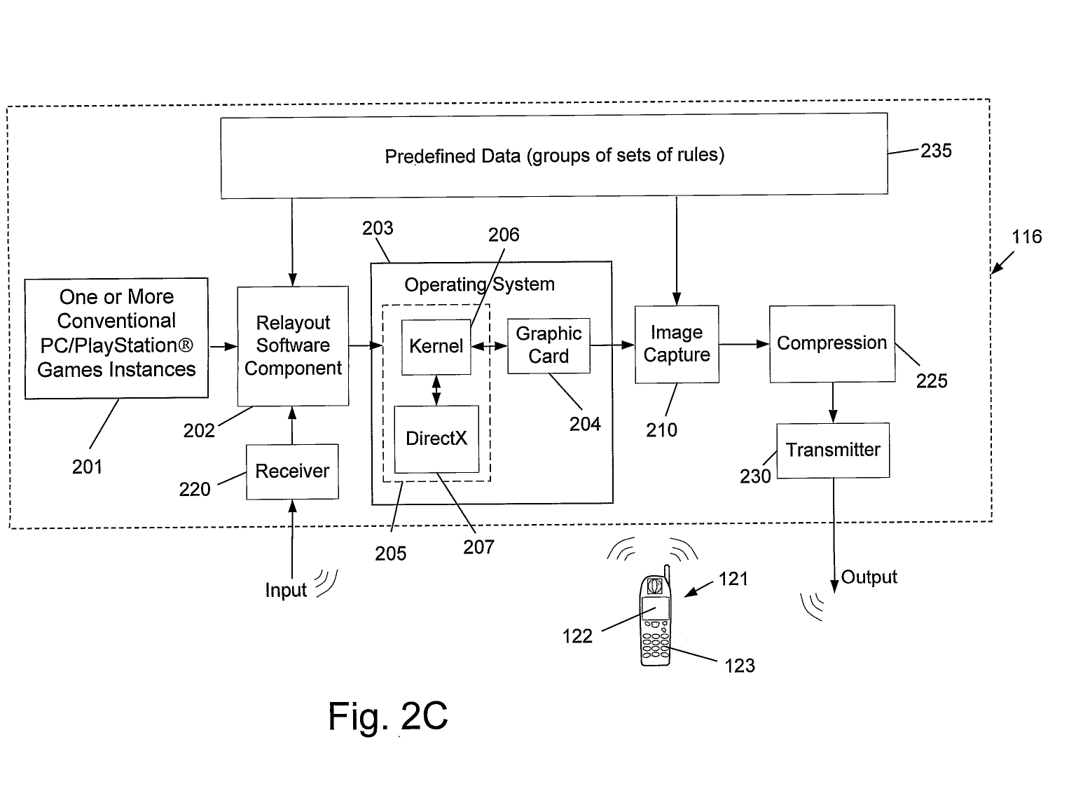

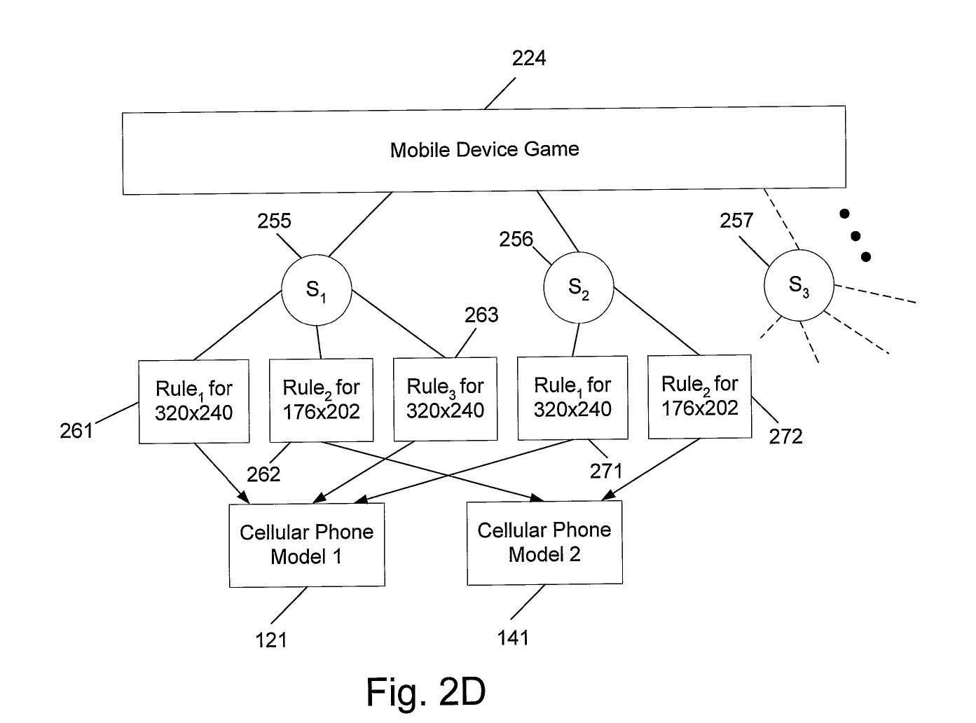

FIG. 2A is a schematic illustration of preparing one or more conventional PC/PlayStation® games 201 for the play on each mobile device, according to a preferred embodiment of the present invention. Each conventional PC/PlayStation® game before being played on a mobile device is preprocessed by a Game Designer 161 of the Games Provider (of the Games/Resource Server provider). Game Designer 161 determines one or more sets of rules for playing each real-time game. For example, the predefined rules can be related to selecting an object or image section within the full image for displaying it on a relatively small screen of the user's mobile device; zooming/unzooming said image section; moving the displayed image section to any direction on said mobile device screen; applying various image processing filters on each game image, such as the image brightness level, gamma level, contract level, frame rate, etc.; determining a compression parameter(s) for compressing each game image according to: (a) the desired quality of the whole image or of a portion of said image; (b) available transmission bandwidth and available number of bits allocated for encoding said each image; and etc. The groups of sets of rules are stored in a Predefined Data software component 235 within Games Server 115 (FIG. 1A). For example, a first group of sets of rules can be related to game image capturing, such as defining a game window size, frame rate, etc.; a second group of sets of rules can be related to image processing, such as applying one or more image processing filters (defining image brightness, contrast, gamma level, etc.) to each game image; a third group of sets of rules can be related to determining corresponding image compression parameters for compressing each game image or for compressing a portion of said each game image, etc.

It should be noted that preprocessing 171 is required for converting a conventional PC/PlayStation® game(s) to a corresponding mobile device game(s) (that can be played on a mobile device having a relatively small screen).

FIG. 2B is a schematic block diagram of Image/Object detection and tracking system 116 located within Games Server 115, according to a preferred embodiment of the present invention. Image/Object detection and tracking system 116 comprises one or more conventional PC/PlayStation® games instances 201; conventional Operating System (OS) software component 201 (comprising a Kernel 206 and a DirectX (or OpenGL (Open Graphics Library), GDI (Graphics Device Interface), GDI+, etc.) 207 software components) for communicating with said games instances 201; conventional Graphic Card 204 for processing and rendering each game; Image Capture software component 210 for capturing game images; Extra-layer software component 215 for: determining in real-time (when playing a game) one or more objects or specific image sections within the captured image; tracking in real-time said objects or image sections and processing the image accordingly; applying one or more image processing filters (defining image brightness, contrast, gamma level, etc.) to each game image, and etc.; Predefined Data software component 235 for providing groups of sets of predefined rules (commands/instructions) to said Image Capture software component, said Extra-layer software component 215, and a Compression software component 225; receiver 220 for receiving user's commands sent by means of keypad 123 of his mobile device 121; a Compression software component 225 for compressing the processed image by a conventional or dedicated compression standard, such JPEG (Joint Photographic Experts Group), MPEG-4 (Moving Picture Experts Group), etc.; and transmitter 230 for transmitting the compressed image to user's mobile device 121.

Each game, originally designed to be played on a personal computer, PlayStation® or the like using the large computer or TV screen, has to be preprocessed before being played on user's mobile device having a relatively small display. Prior to playing a game, for each image within said game is build a look-up table or map, stored within Extra-layer software component 215. The look-up table or map comprises all possible commands (instructions) related to a specific object or image section representation (such as zooming/unzooming, moving the displayed object or image section to any direction within the mobile device screen, adjusting image brightness/contrast levels, etc.). These instructions can be generated by a user during playing a game, or they can be generated by said Extra-layer software component 215. The user wishing to play a game initiates a game instance within Image/Object detection and tracking system 116 located on Games Server 115 (FIG. 1A). Then, Image Capture software component 210 captures in real-time corresponding original game images (of conventional PC/PlayStation® Games Instances 201), according to a group of sets of predefined rules provided by Predefined Data software component 235. Then, Extra-layer software component 215 determines (detects) one or more objects or specific image sections within each original game image (captured by means of Image Capture software component 210) by using conventional image/object recognition algorithms/techniques; traces said objects or image sections according to commands (rules) received from Predefined Data software component 235 or from the mobile device user by means of receiver 220; applies various image processing filters to each game image (e.g., adjusts brightness, gamma or contrast levels, etc.), and processing said image, and said objects or image sections accordingly. Extra-layer software component 215 receives commands from both the mobile device user by means of receiver 220 and from the Predefined Data software component 235. The data stored within Predefined Data software component 235 is preprocessed (predefined) prior to playing the game by means of a Game Designer 161 (FIG. 2A), and it relates, for example, to selecting an object or image section within the full image for displaying it on a relatively small screen of the user's mobile device; zooming/unzooming said image section and moving the displayed image section to any direction on said mobile device screen; applying various image processing filters on each game image, such as the image brightness level, gamma level, contract level, etc.; determining a compression parameter(s) for compressing each game image according to: (a) the desired quality of the whole image or of a portion of said image; (b) available transmission bandwidth and available number of bits allocated for encoding said each image; and etc. During playing the game, this predetermined processing data is inputted (in real-time) into Extra-layer software component 215 for enabling the mobile device user to automatically detect and track one or more objects or image sections within the full image. As a result, a game which was originally designed for a personal computer, PlayStation® and the like using a large display, can be played on a mobile device having a relatively small display. In addition, based on the predetermined processing data provided by Predefined Data software component 235, Extra-layer software component 215 can crop the original image, remaining only the essential image sections or objects to be displayed on user's mobile device screen. The less important image sections or objects may not be displayed.

It is assumed, for the example, that Extra-layer software component 215 during playing the game detects an event (such as the car movement) within the game image, said image captured by means of Image Capture software component 210, and receives X₁, X₂, Y₁ and Y₂ coordinates of corresponding image section or object related to said event from Predefined Data software component 235. Then, said Extra-layer software component 215 resizes the rectangular image section defined by said X₁, X₂, Y₁ and Y₂ coordinates to be fitted into the user's mobile device screen. In addition, Extra-layer software component 215 can crop said rectangular image section prior to resizing it. It should be noted that said Extra-layer software component 215 can perform any other operation that modifies a layout of said rectangular image section, defined by said X₁, X₂, Y₁ and Y₂ coordinates, in order to display said image section on the relatively small mobile device screen. For another example, Extra-layer software component 215 receives from Predefined Data software component 235, during the game, X₁, X₂, Y₁ and Y₂ coordinates along with additional X₃, X₄, Y₃ and Y₄ coordinates, which define the location of an object within said X₁, X₂, Y₁ and Y₂ coordinates. Then, Extra-layer software component 215 determines the location of said object within the rectangular image section, defined by the X₁, X₂, Y₁ and Y₂ coordinates, and after that crops the full image remaining only said rectangular image section. Then, Extra-layer software component 215 resizes the remained rectangular image section to be fitted into the user's mobile device screen. For still another example, Extra-layer software component 215 receives from Predefined Data software component 235, during the game, a set of coordinates related to a number of image sections within the full image. Then, Extra-layer software component 215 crops said image sections within the full image, and after that combines (integrates) them, according to corresponding commands received form Predefined Data software component 235. Finally, Extra-layer software component 215 resizes the combined image to be fitted into the user's mobile device screen.

The user by pressing one or more buttons on keypad 123 of his mobile device 121, instructs Image/Object detection and tracking system 116 for perform one or more corresponding actions, such as selecting an image section within the full image for displaying it on his mobile device screen, zooming/unzooming said image section and moving the displayed image section to any direction on said mobile device screen. When the user (playing a game) wishes, for example, to zoom a specific image section, and he presses a corresponding button on keypad 123 of his mobile device 121, then Extra-layer software component 215 changes the size of the image (displayed on the user's mobile device screen) accordingly. In addition, Extra-layer software component 215 upon receipt from the user a corresponding command, can crop the full image according to look-up table or map values, said look-up table or map stored within said Extra-layer software component 215. Then, the cropped image is compressed and transmitted to the mobile device user.

According to a preferred embodiment of the present invention, each mobile device game image can be generated by relayouting a conventional PC/PlayStation® game image according to groups of sets of rules, predefined in off-line (prior to playing a game) by Game Designer 161 (FIG. 2A) and stored within Predefined Data software component 235. Objects and/or image sections within said PC/PlayStation® game image can be relocated from their original positions to new positions within said image to be fitted on a relatively small mobile device screen. Some objects and/or image sections can be deleted from said PC/PlayStation® game image and some new objects and/or image sections can be inserted into said PC/PlayStation® game image. As a result, a mobile device game image is generated (having a corresponding mobile device game layout) that can be displayed on a mobile device screen.

FIG. 2C is another schematic block diagram of Image/Object detection and tracking system 116 located within Games Server 115, according to another preferred embodiment of the present invention. According to this preferred embodiment, Predefined Data software component 235 further comprises a group of sets of rules, predefined by Game Designer 161 (FIG. 2A) that defines a layout of a mobile device game as to be displayed on user's mobile device that has a relatively small screen. The rules are provided to a Relayout software component 202 that processes said one or more conventional PC/PlayStation® Games Instances 201 according to said rules, similarly to Extra-layer software component 215 (FIG. 2B). It should be noted that said group of sets of rules relate to defining a mobile device game (that can be played on a mobile device) and not to a conventional PC/PlayStation® Game. By providing corresponding rules to said Relayout software component 202, Game Designer 161 can edit game images/scenes (removing, modifying or adding image sections/objects within each image) by filtering API calls to be activated by DirectX software component 207, modifying calls parameters and adding new calls to be activated by said DirectX software component 207.

It should be noted that according to another preferred embodiment of the present invention, the rules provided from Predefined Data software component 235 to Image Capture software component 210, Extra-layer software component 215 (FIG. 2B), Compression software component 225, or Relayout software component 202 are determined in real-time and not pre defined.

In addition, it should be noted that according to a preferred embodiment of the present invention, when using Extra-layer software component 215 (FIG. 2B), the image can be presented and processed in a binary form as a bit image. According to another preferred embodiment of the present invention, when using Relayout software component 202, the image can be presented and processed in a form of polygons.

FIG. 2D is a schematic illustration of applying predefined rules to each mobile device, according to a preferred embodiment of the present invention. It is supposed for example, that the display of cellular phone 121 has the resolution of 320×240 pixels, and the display of cellular phone 141 has the resolution of 176×202 pixels. Extra-layer software component 215 (FIG. 2B) selects in real-time, when users wish to start playing a game, appropriate rules for each mobile device. Thus, Rules 261, 263 and 271 are selected from sets S₁ and S₂ for cellular phone 121, and Rules 262 and 272 are selected from said sets S₁ and S₂ for cellular phone 141. By selecting appropriate rules from predefined sets of rules (such as sets S₁, S₂ and S₃), each mobile device video game 224 (converted from a conventional PC/PlayStation® game) can be played on a variety of mobile devices having different display resolution.

According to a preferred embodiment of the present invention, each mobile device game image can be generated by relayouting a conventional PC/PlayStation® game image according to groups of sets of rules, predefined in off-line (prior to playing a game) by Game Designer 161 (FIG. 2A) and stored within Predefined Data software component 235. Objects and/or image sections within said PC/PlayStation® game image can be relocated from their original positions to new positions within said image to be fitted on a relatively small mobile device screen. Some objects and/or image sections can be deleted from said PC/PlayStation® game image and some new objects and/or image sections can be inserted into said PC/PlayStation® game image. As a result, a mobile device game image is generated (having a corresponding mobile device game layout) that can be displayed on a mobile device screen.

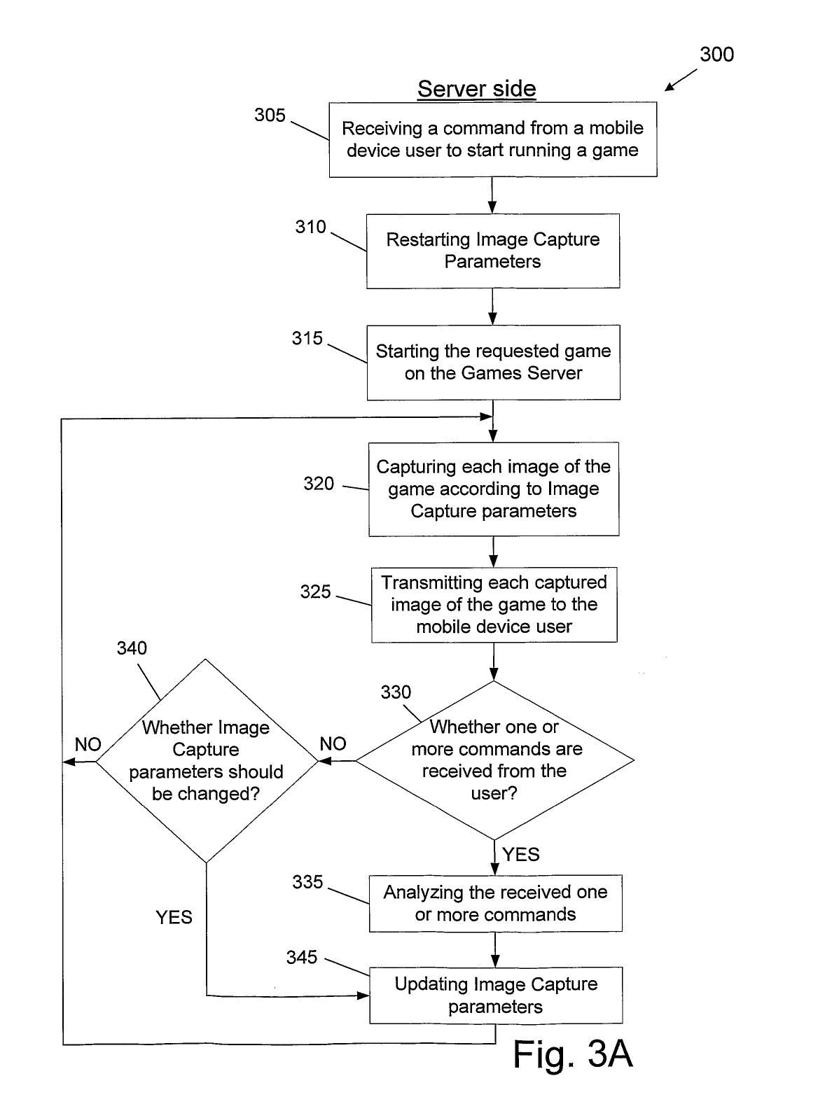

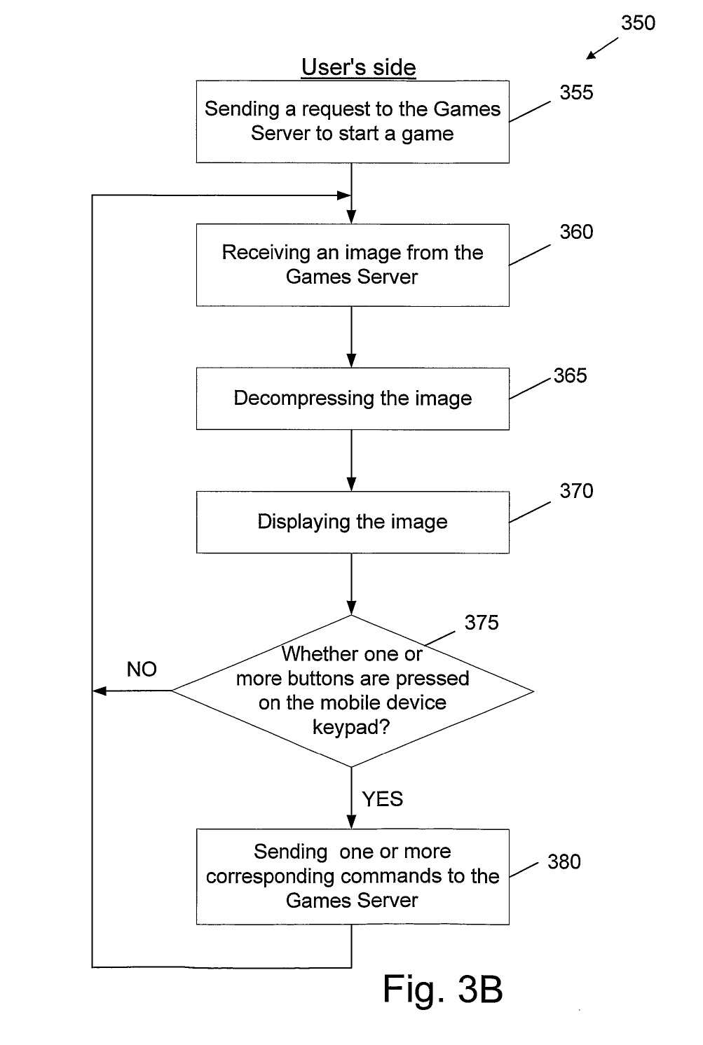

FIG. 3A is a server side flow chart 300 for enabling a user to play a game on his mobile device, according to a preferred embodiment of the present invention. At step 305, Image/Object detection and tracking system 116 receives a command from a mobile device user to start running a game. Then, at step 310, Image Capture parameters are restarted. The game is started on Games Server 115 (FIG. 1A) at step 315 (The game is physically running on Games Server 115). Each image of the game is captured according to the Image Capture parameters at step 320. Then, at step 325, each captured image of the game is transmitted to the mobile device user. At step 330, upon receiving one or more commands from the user by means of his mobile device keypad 123 (FIG. 2) and receiver 220 (FIG. 2), Extra-layer software component 215 analyzes said one or more commands at step 335 and updates Image Capture parameters accordingly, at step 345. If no command is received from the user at step 330, then Extra-layer software component 215 at step 340 checks whether Image Capture parameters should be changed, according to predefined data inputted from Predefined Data software component 235. If the Image Capture parameters should be changed, then Extra-layer software component 215 updates Image Capture parameters accordingly at step 345. Otherwise, the next image of the game is captured at step 320.

FIG. 3B is user's side flow chart 350 for enabling a user to play a game on his mobile device, according to a preferred embodiment of the present invention. At step 355, the user sends a request to Games Server 115 (FIG. 1A) to start a game. The requested game is started on Games Server 115, and the user begins to receive game images at step 360. At step 365, each image is decompressed by means of user's mobile device, such as mobile device 121, 131 or 141 using a corresponding decompression software component (such as Java™ software component) installed within said mobile device. Then, at step 370, the decompressed image is displayed on the screen of said mobile device. If the user presses one or more buttons on the mobile device keypad at step 375 (for selecting an image section, zooming/unzooming, etc.), then corresponding one or more commands are send to receiver 220 (FIG. 2) of Image/Object detection and tracking system 116 (FIG. 2) at step 380. Then at step 360, the user receives a new image from Games Server 115, according to his instructions. If no button is pressed at step 375, then the user receives a new image from Games Server 115 at step 360.

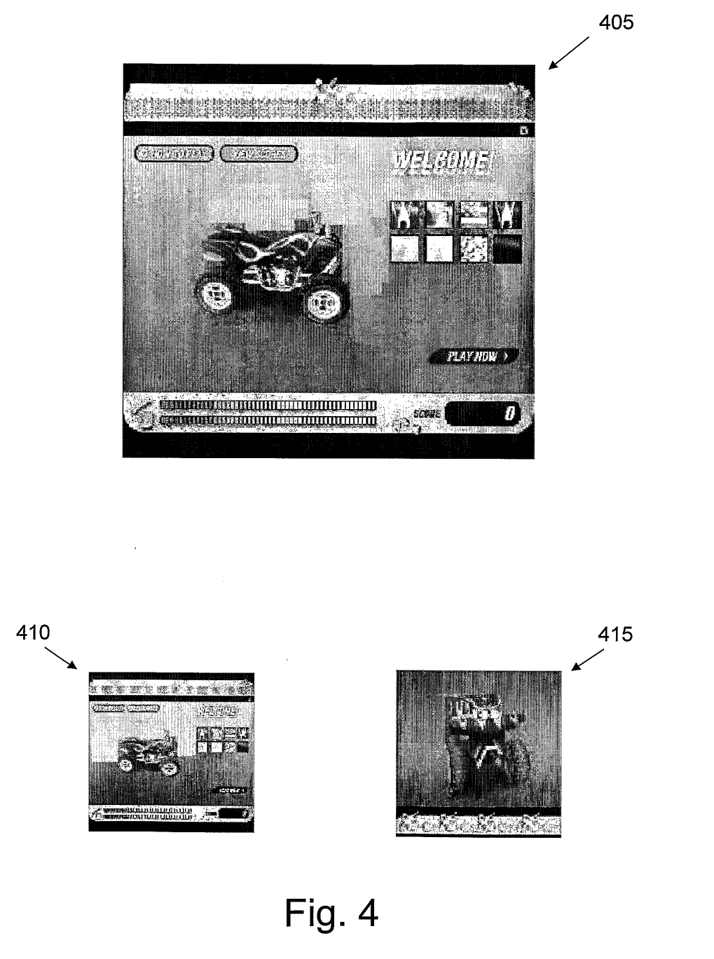

FIG. 4 illustrates sample game images screenshots, according to a preferred embodiment of the present invention. Image 405 is a full original image to be displayed on a large screen (of personal computer, PlayStation®, etc.). Image 410 is created by resizing full original image 405 for displaying it on user's mobile device screen 122 (FIG. 2). Image 415 is created by cropping and processing said full original image 405 using Extra-layer software component 215 (FIG. 2) or using Relayout software component 202 (FIG. 2C), said Image 415 to be displayed on a relatively small mobile device screen 122.

Each mobile device image, such as Image 415 is generated by applying rules to the full original PC/PlayStation® image 405. Groups of sets of rules are provided in real-time (when playing a mobile device game) by predefined data software component 235 (FIG. 2B) and applied to Image Capture software component 210 (FIG. 2B), Extra-layer software component 215 (FIG. 2B), Compression software component 225 (FIG. 2B), and/or Relayout software component 202 (FIG. 2C). According to a preferred embodiment of the present invention, the groups of set of rules are determined in off-line by Game Designer 161 (FIG. 2A) prior to playing a game, or in real-time by said Extra-layer software component 215. As a result, each mobile device image, such as Image 415 has a corresponding mobile device layout, and can be displayed on a mobile device screen.

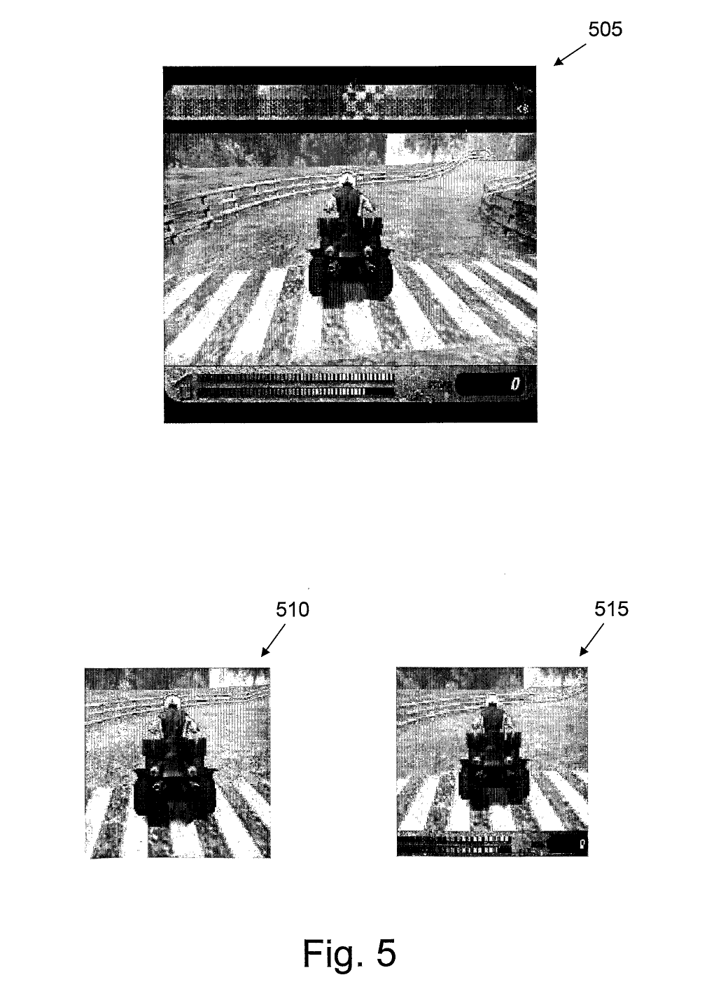

FIG. 5 illustrates additional sample game images screenshots, according to another preferred embodiment of the present invention. Image 505 is a full original image to be displayed on a large screen. Image 510 is created by determining an object (a men driving a tractor), cropping the corresponding image section, comprising said object, from said full original image 505, and centralizing said object within said image section. Image 515 is created by modifying (editing) the layout of image 510 by means of Extra-layer software component 215 (FIG. 2) or by means of relayout software component 202 (FIG. 2C), and adding to said image 510 a panel representing user's game score and other essential game parameters.

According to a preferred embodiment of the present invention, each mobile device game image can be generated by relayouting a conventional PC/PlayStation® game image according to groups of sets of rules, predefined in off-line (prior to playing a game) by Game Designer 161 (FIG. 2A) and stored within Predefined Data software component 235. Objects and/or image sections within said PC/PlayStation® game image can be relocated from their original positions to new positions within said image to be fitted on a relatively small mobile device screen. Some objects and/or image sections can be deleted from said PC/PlayStation® game image and some new objects and/or image sections can be inserted into said PC/PlayStation® game image. As a result, a mobile device game image is generated, having a corresponding mobile device game layout instead of a PC/PlayStation® game layout, that can be displayed on a mobile device screen.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. A system for determining and tracking one or more objects, or one or more image sections within each image of a video stream to be displayed on user's mobile device, comprising:
a. one or more video streams to be run on a streaming server;
b. an image capture software component for capturing images of said one or more video streams, according to a first group of one or more sets of rules;
c. a receiver for receiving one or more commands generated by a user and transferring said commands to an extra-layer software component;
d. an extra-layer software component for:
d.1. determining one or more objects or image sections within the captured images;
d.2. tracking said objects or image sections within said captured images; and
d.3. processing said captured images,
to generate corresponding images to be displayed on a mobile device screen, according to a second group of one or more sets of rules and according to user's commands received by means of said receiver;
e. a compression software component for compressing the images, processed by means of said extra-layer software component, according to a third group of one or more sets of rules;
f. a data software component for providing groups of one or more sets of rules to said image capture software component, said extra-layer software component and said compression software component; and
g. a transmitter for transmitting the compressed images to a mobile device.

2. A system for determining and tracking one or more objects, or one or more image sections within each image of a video stream to be displayed on user's mobile device, comprising:
a. one or more video streams to be run on a streaming server;
b. a receiver for receiving one or more commands generated by a user and transferring said commands to an extra-layer software component;
c. a relayout software component for:
c.1. determining one or more objects or image sections within each image of said one or more video streams;
c.2. tracking said objects or image sections within said each image of said one or more video streams; and
c.3. processing said each image,
to generate corresponding images to be displayed on a mobile device screen, according to a first group of one or more sets of rules and according to user's commands received by means of said receiver;
d. an image capture software component for capturing said corresponding images to be displayed on a mobile device screen, according to a second group of one or more sets of rules;
e. a compression software component for compressing said corresponding images to be displayed on a mobile device screen, according to a third group of one or more sets of rules;
f. a data software component for providing groups of one or more sets of rules to said relayout software component, said image capture software component and said compression software component; and
g. a transmitter for transmitting the compressed images to a mobile device.

3. System according to claim 1, wherein the images belong to a video game.

4. System according to claim 1, wherein the compressed images are decompressed in the mobile device and then displayed on the screen of said mobile device.

5. System according to claim 1, wherein tracking the one or more objects or the one or more image sections within each image is performed in real-time.

6. System according to claim 1, wherein the groups of sets of rules stored within the data software component, or the one or more commands generated by the user relate to one or more of the following:
a. selecting the object or image section within the one or more corresponding images displayed on the mobile device screen;
b. zooming or unzooming the object or image section within said one or more corresponding images;
c. moving the displayed image to any direction within said mobile device screen;
d. applying one or more image processing filters to said one or more corresponding images; and
e. determining one or more image compression parameters for compressing each corresponding image or for compressing a portion of said each corresponding image.

7. System according to claim 1, wherein the extra-layer software component further crops one or more images, according to the second group of sets of rules provided by the data software component, or according to the one or more commands generated by the user and received by means of the receiver.

8. System according to claim 2, wherein the relayout software component further crops one or more images, according to the first group of sets of rules provided by the data software component, or according to the one or more commands generated by the user and received by means of the receiver.

9. System according to claim 1, wherein the extra-layer software component modifies a layout of each captured image, generating corresponding images to be displayed on the mobile device screen, according to the second group of sets of rules provided by the data software component, or according to the one or more commands generated by the user and received by means of the receiver.

10. System according to claim 2, wherein the relayout software component modifies a layout of each image within the video stream, generating corresponding images to be displayed on the mobile device screen, according to the first group of sets of rules provided by the data software component, or according to the one or more commands generated by the user and received by means of the receiver.

11. A method for determining and tracking one or more objects, or one or more image sections within each image of a video stream to be displayed on user's mobile device, comprising:
a. providing one or more video streams to be run on a streaming server;
b. providing an image capture software component for capturing images of said one or more video streams, according to a first group of one or more sets of rules;
c. providing a receiver for receiving one or more commands generated by a user and transferring said commands to an extra-layer software component;
d. providing an extra-layer software component for:
d.1. determining one or more objects or image sections within the captured images;
d.2. tracking said objects or image sections within said captured images; and
d.3. processing said captured images,
to generate corresponding images to be displayed on a mobile device screen, according to a second group of one or more sets of rules and according to user's commands received by means of said receiver;
e. providing a compression software component for compressing the images, processed by means of said extra-layer software component, according to a third group of one or more sets of rules;
f. providing a data software component for providing groups of one or more sets of rules to said image capture software component, said extra-layer software component and said compression software component; and
g. providing a transmitter for transmitting the compressed images to a mobile device.

12. A method for determining and tracking one or more objects, or one or more image sections within each image of a video stream to be displayed on user's mobile device, comprising:
a. providing one or more video streams to be run on a streaming server;
b. providing a receiver for receiving one or more commands generated by a user and transferring said commands to an extra-layer software component;
c. providing a relayout software component for:
c.1. determining one or more objects or image sections within each image of said one or more video streams;
c.2. tracking said objects or image sections within said each image of said one or more video streams; and
c.3. processing said each image,
to generate corresponding images to be displayed on a mobile device screen, according to a first group of one or more sets of rules and according to user's commands received by means of said receiver;
d. providing an image capture software component for capturing said corresponding images to be displayed on a mobile device screen, according to a second group of one or more sets of rules;
e. providing a compression software component for compressing said corresponding images to be displayed on a mobile device screen, according to a third group of one or more sets of rules;
f. providing a data software component for providing groups of one or more sets of rules to said relayout software component, said image capture software component and said compression software component; and
g. providing a transmitter for transmitting the compressed images to a mobile device.

13. Method according to claim 11, further comprising providing the images that belong to a video game.

14. Method according to claim 11, further comprising decompressed images in the mobile device and then displaying them on the screen of said mobile device.

15. Method according to claim 11, further comprising tracking the one or more objects or the one or more image sections within each image in real-time.

16. Method according to claim 11, further comprising providing the groups of sets of rules stored within the data software component, or the one or more commands generated by the user that relate to one or more of the following:
a. selecting the object or image section within the one or more corresponding images displayed on the mobile device screen;
b. zooming or unzooming the object or image section within said one or more corresponding images;
c. moving the displayed image to any direction within said mobile device screen;
d. applying one or more image processing filters to said one or more corresponding images; and
e. determining one or more image compression parameters for compressing each corresponding image or for compressing a portion of said each corresponding image.

17. Method according to claim 11, further comprising cropping by means of the extra-layer software component one or more images, according to the second group of sets of rules provided by the data software component, or according to the one or more commands generated by the user and received by means of the receiver.

18. Method according to claim 12, further comprising cropping by means of the relayout software component one or more images, according to the first group of sets of rules provided by the data software component, or according to the one or more commands generated by the user and received by means of the receiver.

19. Method according to claim 11, further comprising modifying by means of the extra-layer software component a layout of each captured image, generating corresponding images to be displayed on the mobile device screen, according to the second group of sets of rules provided by the data software component, or according to the one or more commands generated by the user and received by means of the receiver.

20. Method according to claim 12, further comprising modifying by means of the relayout software component a layout of each image within the video stream, generating corresponding images to be displayed on the mobile device screen, according to the first group of sets of rules provided by the data software component, or according to the one or more commands generated by the user and received by means of the receiver.
